(19) United States
(12) Patent Application Publication
(10) Pub. No.: US 2025/0386304 A1
(43) Pub. Date: Dec. 18, 2025

(54) POWER HEADROOM REPORT

(71) Applicant: QUALCOMM Incorporated, San Diego, CA (US)

(72) Inventors: Preeti Kumari, San Diego, CA (US); Kapil Gulati, Belle Mead, NJ (US); Shijun Wu, San Diego, CA (US); Stelios Stefanatos, San Diego, CA (US); Junyi Li, Greentown, PA (US)

(21) Appl. No.: 19/157,604

(22) PCT Filed: Mar. 28, 2024
(86) PCT No.: PCT/US2024/021923

§ 371 Date: Aug. 18, 2025

(30) Foreign Application Priority Data
Apr. 20, 2023 (GR) 20230100335

(51) Int. Cl. H04W 52/36

(52) U.S. Cl. CPC H04W 52/365

(57) ABSTRACT

This disclosure provides systems, methods, and devices for wireless communication that support a sensing charging subscription. In a first aspect, a method of wireless communication includes generating a power headroom report associated with or for communication during a joint communication-radar sensing mode. The method further includes transmitting the power headroom report. Other aspects and features are also claimed and described.

### CROSS-REFERENCE TO RELATED APPLICATIONS

This application claims the benefit of Greek patent application No. 20230100335, entitled, “POWER HEADROOM REPOT,” filed on Apr. 20, 2023, which is expressly incorporated by reference herein in its entirety.

### TECHNICAL FIELD

Aspects of the present disclosure relate generally to wireless communication systems, and more particularly, to a power headroom report, such as a power headroom report for joint communication and radar (JCR) sensing (e.g., for communication during a JCR sensing mode). Some features may enable and provide sensing operation management and control, reduced overhead signaling, efficient spectrum usage, reduced device hardware, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

In a joint communication and radar (JCR) system, a user equipment (UE) may use different transmit (Tx) beams for sensing and communication to communicate with another device while simultaneously performing sensing, such as monostatic sensing. However, as compared to a communication only beam, the sensing beam may reduce communication transmit beam gain when sensing is performed concurrently with the communication beam. Additionally, the UE may generate and communicate a power headroom report (PHR) for communication; however, the PHR report in JCR modes does not reflect the impact of the sensing beam on the communication beam, which may lead to an erroneous communication transmit parameter setting, such as bandwidth, minimum communication range (MCR), or carrier aggregation configuration.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication is performed by a user equipment (UE). The method includes generating a power headroom report associated with communication during a joint communication and radar (JCR) sensing mode. The method further includes transmitting the power headroom report.

In an additional aspect of the disclosure, an apparatus includes at least one processor and a memory coupled to the at least one processor. The at least one processor is configured to generate a power headroom report associated with communication during a JCR sensing mode. The at least one processor is also configured to transmit the power headroom report.

In an additional aspect of the disclosure, an apparatus includes at least one processor coupled to a memory storing processor-readable code. The at least one processor is configured to execute the processor-readable code to cause the at least one processor to generate a power headroom report associated with communication during a JCR sensing mode. The apparatus further includes a communication interface configured to transmit the power headroom report.

In an additional aspect of the disclosure, an apparatus includes means for generating a power headroom report associated with communication during a JCR sensing mode. The apparatus further includes means for transmitting the power headroom report.

In an additional aspect of the disclosure, a non-transitory computer-readable medium stores instructions that, when executed by a processor, cause the processor to perform operations. The operations include generating a power headroom report associated with communication during a JCR sensing mode. The operations further include transmitting the power headroom report.

In one aspect of the disclosure, a method for wireless communication is performed by a network entity. The method includes receiving, from a UE, a power headroom report associated with communication during a JCR sensing mode. The method further includes communicating with the UE based on the power headroom report.

In an additional aspect of the disclosure, an apparatus includes at least one processor and a memory coupled to the at least one processor. The at least one processor is configured to receive, from a UE, a power headroom report associated with communication during a JCR sensing mode. The at least one processor is further configured to communicate with the UE based on the power headroom report.

In an additional aspect of the disclosure, an apparatus includes at least one processor coupled to a memory storing processor-readable code. The at least one processor is configured to execute the processor-readable code to cause the at least one processor to receive, from a UE, a power headroom report associated with communication during a JCR sensing mode. The apparatus further includes a communication interface configured to communicate with the UE based on the power headroom report.

In an additional aspect of the disclosure, an apparatus includes means for receiving, from a UE, a power headroom report associated with communication during a JCR sensing mode. The apparatus further includes means for communicating with the UE based on the power headroom report.

In an additional aspect of the disclosure, a non-transitory computer-readable medium stores instructions that, when executed by a processor, cause the processor to perform operations. The operations include receiving, from a UE, a power headroom report associated with communication during a JCR sensing mode. The operations further include communicating with the UE based on the power headroom report.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports a power headroom report according to one or more aspects.

FIG. 5 is a diagram illustrating an example of operations that support a power headroom report according to one or more aspects.

FIG. 6 is a diagram illustrating another example of operations that support a power headroom report according to one or more aspects.

FIG. 7 is a diagram illustrating another example of operations that support a power headroom report according to one or more aspects.

FIG. 8 is a flow diagram illustrating an example process that supports a power headroom report according to one or more aspects.

FIG. 9 is a block diagram of an example UE that supports a power headroom report according to one or more aspects.

FIG. 10 is a flow diagram illustrating an example process that supports a power headroom report according to one or more aspects.

FIG. 11 is a block diagram of an example base station that supports a power headroom report according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support a power headroom report, such as a power headroom report for joint communication and radar sensing (e.g., for communication during a joint communication-radar sensing mode). For example, the present disclosure describes generating a power headroom report associated with or for communication during a joint communication and radar (JCR) sensing mode. In some implementations, the power headroom report may be generated based on a change in a mode, such as a change to or from the JCR sensing mode or a change to or from a sensing configuration of the JCR sensing mode. The sensing configuration may be selected by a user equipment (UE) or indicated by a network entity, such as a base station. The power headroom report may be transmitted to a network entity, such as a base station. In some implementations, the power headroom report may be generated based on or be associated with a change in transmit power during a sensing operation or based on a sensing beam. In some implementations, the power headroom report may indicate a transmit (Tx) power for a sensing configuration, a power headroom for a sense beam associated with a sensing configuration, a number of radar sensing beam, a power headroom for a communication mode, or a combination thereof. Additionally, or alternatively, the power headroom report may indicate for at least one radar sensing beam of one or more radar sensing beams, a power headroom of the at least one sensing beam, a beamwidth of the at least one radar sensing beam, a beam direction of the at least one radar sensing beam, or a combination thereof. The power headroom report may be generated or transmitted periodically during the JCR sensing mode, at a start of a sensing transmission based on a sensing configuration, based on a time indicated by a base station, based on a change in power headroom for a sensing configuration that is greater than or equal to a threshold, or a combination thereof.

Particular implementations of the subject matter described in this disclosure may be implemented to realize one or more of the following potential advantages or benefits. In some aspects, the present disclosure provides techniques for supporting a power headroom report. For example, the techniques described provide techniques, information, and signaling for the UE to generate a power headroom report for communication during a joint communication-radar sensing mode. The power headroom report may enable setting of one or more communication transmit parameter settings, such as a bandwidth, a minimum communication range (MCR), or a carrier aggregation configuration.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IOTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜ 10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

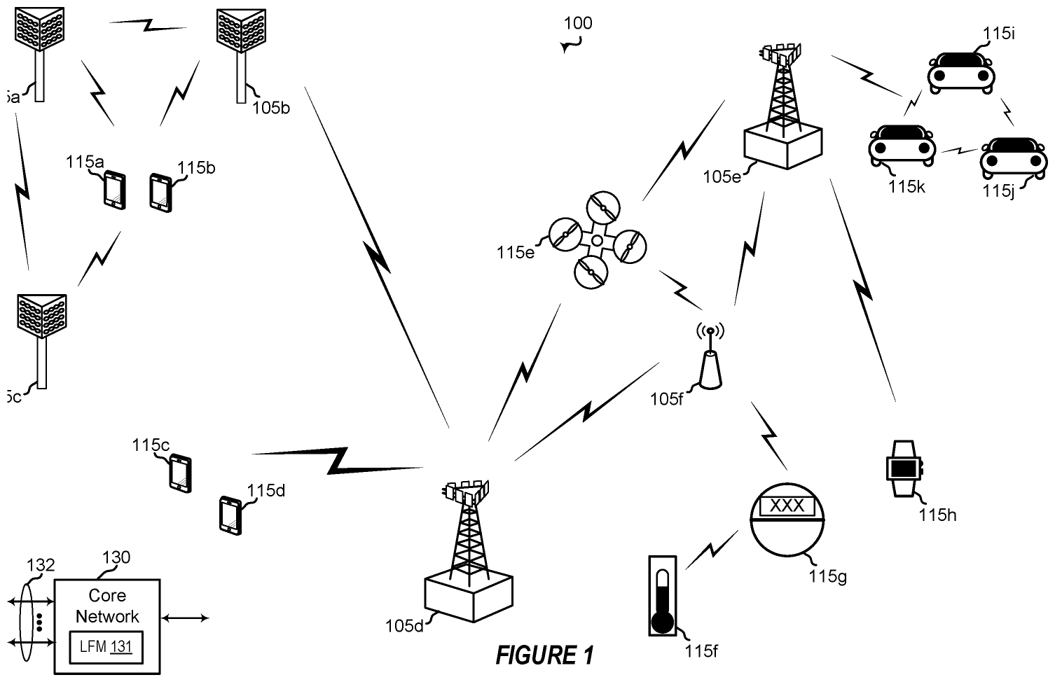

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (COMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a Location Management Function (LMF) 131, which is an entity in the 5G Core Network (5GC) supporting various functionality, such as managing support for different location services for one or more UEs. For example the LMF 131 may include one or more servers, such as multiple distributed servers. Base stations 105 may forward location messages to the LMF 131 and may communicate with the LMF via a NR Positioning Protocol A (NRPPa). The LMF 131 is configured to control the positioning parameters for UEs 115 and the LMF 131 can provide information to the base stations 105 and UE 115 so that action can be taken at UE 115. In some implementations, UE 115 and base station 105 are configured to communicate with the LMF 131 via an Access and Mobility Management Function (AMF).

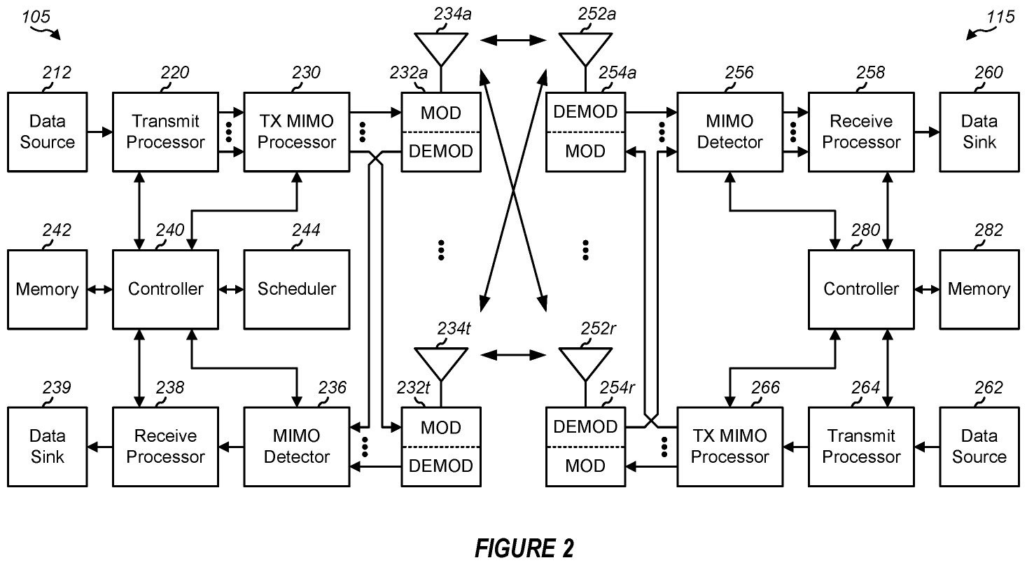

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in or described with reference to FIGS. 1-11, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

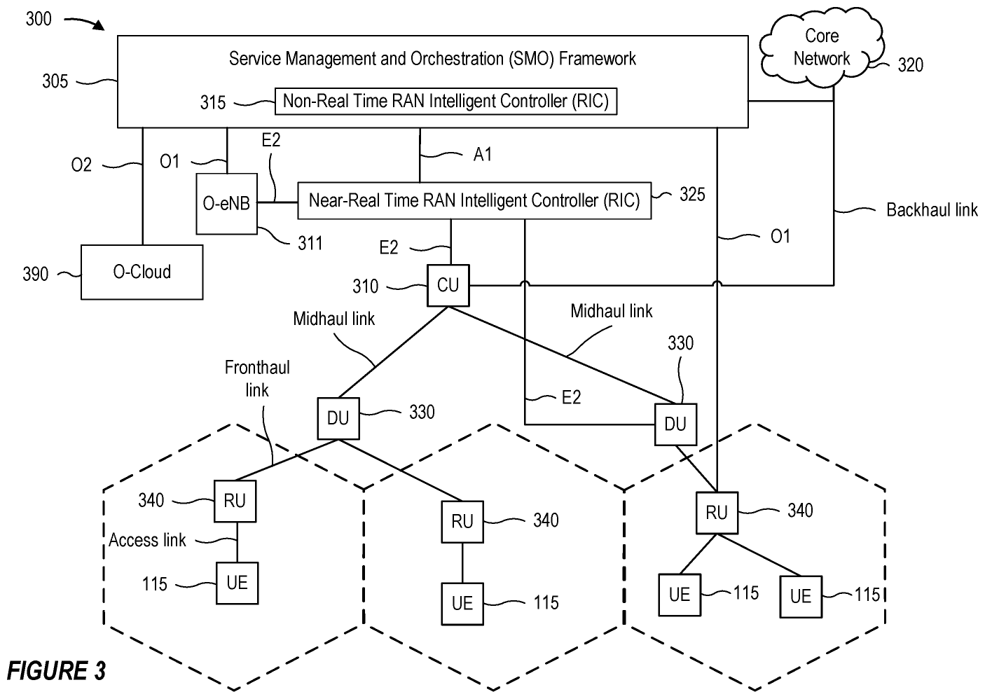

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUS 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

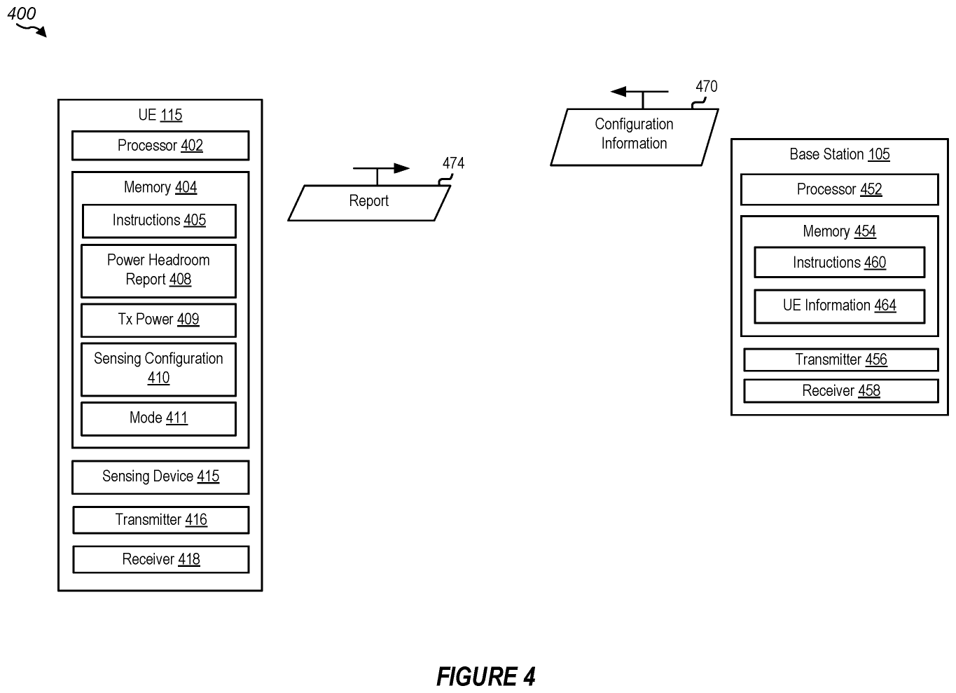

FIG. 4 is a block diagram of an example wireless communications system 400 that supports a power headroom report according to one or more aspects. In some examples, wireless communications system 400 may implement aspects of wireless network 100. Wireless communications system 400 includes UE 115 and base station 105. In some implementations, base station 105 and core network 130 may be individually or collectively referred to as a network, a network device, or a network system. Although one UE 115, and one base station 105 are illustrated, in some other implementations, wireless communications system 400 may generally include multiple UEs 115, multiple base stations 105, or a combination thereof.

UE 115 may include a device, such as a mobile device or a vehicle. UE 115 may be configured to performing sensing using one or more uplink (UL) resources. For example, sensing may include bi-static sensing or monostatic sensing. When UE 115 is a vehicle, UE 115 may perform one or more sensing operations to sense an environment, such as an indoor environment of the vehicle or an outdoor environment of the vehicle. To illustrate, UE 115 may sense for surrounding objects for automotive applications, such as collision avoidance. To enable UE side sensing, such as a joint communication and radar (JCR) sensing, the UL resources (e.g., communication resources) can be reused for sensing. For example, the UL resources may be shared between communication and radar modes. To illustrate, in some implementations, there could be separate resources for communication or radar that are used based on a TDM mode. In some such implementations, an SRS can be utilized as a sensing waveform. Alternatively, the same resource for communication and radar may be used that has a join co-design waveform.

UE 115 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more sensing devices 415 (hereinafter referred to collectively as “sensing device 415”), one or more transmitters 416 (hereinafter referred to collectively as “transmitter 416”), and one or more receivers 418 (hereinafter referred to collectively as “receiver 418”). Sensing device 415 may include or correspond to a bi-static sensing device. In some implementations, UE 115 may include an interface (e.g., a communication interface, a sensing interface, or a combination thereof) that includes transmitter 416, receiver 418, or a combination thereof. Processor 402 may be configured to execute instructions 405 stored in memory 404 to perform the operations described herein. In some implementations, processor 402 includes or corresponds to one or more of receive processor 258, transmit processor 264, and controller 280, and memory 404 includes or corresponds to memory 282.

Memory 404 includes or is configured to store instructions 405, a power headroom report 408, a transmit (Tx) power 409, a sensing configuration 410, and a mode 411. Power headroom report 408 may include or indicate a remaining amount of power, such as transmission power, that is left for UE 115 to use in addition to power being used by a transmission. In some implementations, power headroom report 408 may include or indicate a power headroom report for communication during joint communication-radar sensing (JCS) mode (e.g., mode 411). In some implementations, power headroom report includes or indicates a power headroom for a one or more modes (e.g., 411), one or more sensing configurations (e.g., 410), one or more beams, or a combination thereof. Additionally, or alternatively, power headroom report 408 may include or indicate, for a sensing mode configuration (e.g., 410), number of radar beams, a beamwidth for each beam, a pointing direction for each beam, or a combination thereof.

Tx power 409 include or indicate a max UE Tx power, a power headroom, an amount of Tx power used for a communication, Tx power used for or associated with a sensing configuration (e.g., 410), or a combination thereof. Sensing configuration 410 may include or indicate a configuration of UE 115 for performing one or more sensing operations. Sensing configuration 410 may include or correspond to a radar sensing configuration. For example, the sensing configuration may be associated with a configuration for a monostatic sensing operation. In some implementations, sensing configuration 410 may include or indicate a number of radar beams, a beamwidth for each beam, a pointing direction for each beam, or a combination thereof. Mode 411 may include or indicate a joint communication sensing mode, a communication mode, or a sensing mode, as illustrative, non-limiting examples.

Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, base station 105. In some implementations, transmitter 416 and receiver 418 may be integrated in one or more transceivers. Additionally or alternatively, transmitter 416 or receiver 418 may include or correspond to one or more components of UE 115 described with reference to FIG. 2.

Sensing device 415 may be configured to be used in a sensing operation. In some implementations, sensing device 415 is associated with a joint communication and radar (JCR) system. The JCR system may be categorized as a cooperative JCR system or a co-design of communication and radar systems. For example, sensing device 415 may be associated with the co-design of communication and radar systems. Although described as being separate from transmitter 416 and receiver 418, in other implementations, sensing device 415 may include transmitter 416 and receiver 418, transmitter 416 but not receiver 418, or may include receiver 418 but not transmitter 416. In some implementations, sensing device 415 is configured for two-stage UL sensing, such as a scanning phase and a tracking phase.

In some implementations, UE 115 may include one or more antenna arrays. The one or more antenna arrays may be coupled to or include sensing device 415, transmitter 416, receiver 418, a communication interface, a sensing interface, or a combination thereof. The antenna array may include multiple antenna elements configured to perform wireless communications with other devices, such as with the base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

UE 115 may include one or more components as described herein with reference to UE 115 of FIG. 2. In some implementations, UE 115 is a 5G-capable UE, a 6G-capable UE, or a combination thereof.

Base station 105 may include a variety of components (such as structural, hardware components) used for carrying out one or more functions described herein. For example, these components may include one or more processors 452 (hereinafter referred to collectively as “processor 452”), one or more memory devices 454 (hereinafter referred to collectively as “memory 454”), one or more transmitters 456 (hereinafter referred to collectively as “transmitter 456”), and one or more receivers 458 (hereinafter referred to collectively as “receiver 458”). In some implementations, base station 105 may include an interface (e.g., a communication interface) that includes transmitter 456, receiver 458, or a combination thereof. Processor 452 may be configured to execute instructions 460 stored in memory 454 to perform the operations described herein. In some implementations, processor 452 includes or corresponds to one or more of receive processor 238, transmit processor 220, and controller 240, and memory 454 includes or corresponds to memory 242.

Memory 354 includes or is configured to store instructions 460 and UE information 464. In some implementations, UE information 464 may include or correspond to power headroom report 408, Tx power 409, sensing configuration 410, mode 111, configuration information 470, power headroom report 474, or a combination thereof.

Transmitter 456 is configured to transmit reference signals, synchronization signals, control information and data to one or more other devices, and receiver 458 is configured to receive reference signals, control information and data from one or more other devices. For example, transmitter 456 may transmit signaling, control information and data to, and receiver 458 may receive signaling, control information and data from, UE 115. In some implementations, transmitter 456 and receiver 458 may be integrated in one or more transceivers. Additionally, or alternatively, transmitter 456 or receiver 458 may include or correspond to one or more components of base station 105 described with reference to FIG. 2.

In some implementations, base station 105 may include one or more antenna arrays. The antenna array may include multiple antenna elements configured to perform wireless communications with other devices, such as with the UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the base station 105. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, wireless communications system 400 implements a 5G NR network. For example, wireless communications system 400 may include multiple 5G-capable UEs 115 and multiple 5G-capable base stations 105, such as UEs and base stations configured to operate in accordance with a 5G NR network protocol such as that defined by the 3GPP. In some other implementations, wireless communications system 400 implements a 6G network.

In some implementations, UE 115 or sensing device 415 may be associated with a JCR system. The JCR system provide advantages and benefits of at least helping radar or radar helping communication, spectrum reuse, hardware reuse, or a combination thereof. The JCR system may be categorized as a cooperative JCR system or a co-design of communication and radar systems. In the cooperative JCR system, information may be shared between the communication and radar systems to improve performance, without much altering core operation of radar and communication systems. The cooperative JCR system provides advantages and benefits of at least spectrum reuse and ease of implementation. In the co-design of communication and radar systems, a common transmitter or receiver is used for both communication and radar functionalities. The co-design of communication and radar systems may require modification in the transmit waveform generation or the receiver processing of both or either of the systems. The co-design of communication and radar systems provide advantages and benefits of at least reduced hardware and spectrum reuse.

In some implementations, UE 115 may be configured to generate power headroom report 408 (e.g., power headroom report 474). For example, power headroom report 408 may be associated with or for NR communications. To illustrate, power headroom report 408 may indicate how much transmission power is left (e.g., power headroom) for UE 115 to use in addition to the power being used by a current transmission. Stated differently, power headroom may be described as:

$$PH = Max UE Tx Power - \{ PUSCH Tx Power + b \} ; or$$

$$PH = {P}_{MAX} - \{ {P}_{PUSCH} + b \} ,$$

where b is a function of communication channel's path loss, subcarrier spacing, allocated RBs, and closed loop power control component. The exact expression of b may depend on the type of transmission and whether the PHR is based on real transmission or a reference format. A ‘Type l’ report is based on PUSCH transmission. A ‘Type 3’ report is included when an actual SRS transmission is available but an actual PUSCH transmission is unavailable.

In some implementations, base station 105 may receive power headroom report 408 or 474. Base station 105 may use power headroom report 408 or 474 while in a communication mode or performing one or more communication operations with UE 115. For example, base station 105 may, based on power headroom report 408 or 474, make one or more determinations. For example, base station 105 may, based on power headroom report 408 or 474, estimate how much uplink BW can be used for a specific subframe, restrict an MCS selection, calculate a path loss, or a combination thereof. The one or more determination may be used by base station 105 to enable (or disable) specific functionality, such as to configure UE 115 with uplink carrier aggregation when the path loss is low, or to configure UE 115 with single carrier when the path loss becomes high.

In some implementations, UE 115 may indicate a max UE Tx power, PMAX, to base station 105. For example, the max UE Tx power may be included in or indicated by power headroom report 408 or 474. In some such implementations, base station 105 may use the max UE Tx power PMAX to calculate path loss. Additionally, or alternatively, in some implementations, the max UE Tx power PMAX may be included when the power headroom result is generated based on a real transmission.

In some implementations, generation or transmission of power headroom report 408 or 474 may be triggered based on one or more conditions. For example, the one or more conditions may include a path loss change being greater than or equal to a threshold. For example, UE 115 can calculate the path loss based on a reference signal (RS) power notified by the network (e.g., base station 105) and a measured RS power at an antenna port of UE 115. If the pathloss value changes over a certain threshold (e.g., is greater than or equal to the threshold), UE 115 may transmit power headroom report 408 or 474. As another example, UE 115 may transmit power headroom report 408 or 474 periodically (e.g., based on a timer). In some other implementations, UE 115 may use a timer to indicate a time period during which UE 115 is prohibited from sensing.

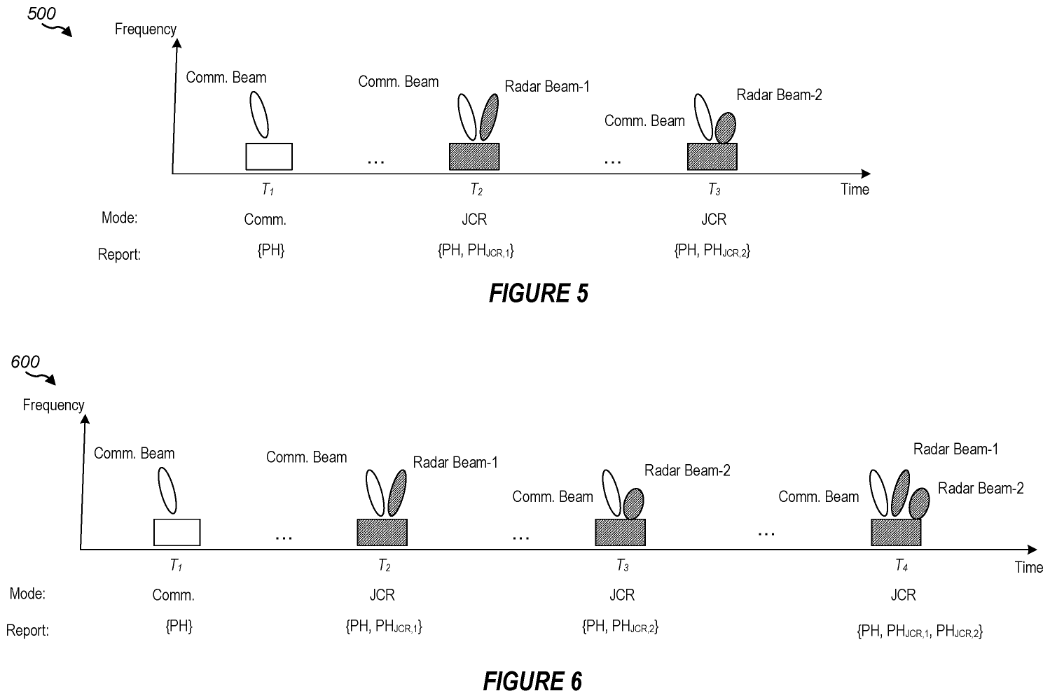

Referring to FIGS. 5 and 6, examples of operations that support that support a power headroom report according to one or more aspects are shown. For example, FIG. 5 shows an example 500 of operations that support a power headroom report according to one or more aspects and FIG. 6 shows another example 600 of operations that support a power headroom report according to one or more aspects. To illustrate, the operations may be performed by UE 115.

FIGS. 5 and 6 show communication at different times and indicates, for each time, a corresponding mode (e.g., 411) and report (e.g., power headroom report 408). To illustrate, at a first time T₁, UE 115 operates in a communication only mode with a communication beam and is configured to provide a power headroom report {PH}.

At a second time T₂, UE 115 operates in a JCR mode. The JCR mode at the second time T₂ includes a communication beam and a first radar beam (radar beam-1). The first radar beam (radar beam-1) may be associated with a first sensing configuration (e.g., 410). In association with the JCR mode at the second time T₂, UE 115 may be configured to generate a power headroom report {PH, PH_{JCR,1}}, where PH is a power headroom associated with the communication only mode and PH_{JCR,1} is a power headroom associated with the first sensing configuration or the first radar beam (radar beam-1).

At a third time T₃, UE 115 operates in a JCR mode. The JCR mode at the third time T₃ includes a communication beam and a second radar beam (radar beam-2). The second radar beam (radar beam-2) may be associated with a second sensing configuration (e.g., 410). In association with the JCR mode at the third time T₃, UE 115 may be configured to generate a power headroom report {PH, PH_{JCR,2}}, where PH is a power headroom associated with the communication only mode and PH_{JCR,2} is a power headroom associated with the second sensing configuration or the second radar beam (radar beam-2).

Referring to FIG. 6, as compared to FIG. 5, FIG. 6 includes an operation at a fourth time T₄. At the fourth time T₄, UE 115 operates in a JCR mode. The JCR mode at the fourth time T₄ includes a communication beam, the first radar beam (radar beam-1), and the second radar beam (radar beam-2). The first radar beam (radar beam-1) may be associated with the first sensing configuration and the second radar beam (radar beam-2) may be associated with the second sensing configuration (e.g., 410). Additionally, or alternatively, the first radar beam (radar beam-1) and the second radar beam (radar beam-2) may be associated with a third sensing configuration (e.g., 410). In association with the JCR mode at the fourth time T₄, UE 115 may be configured to generate a power headroom report {PH, PH_{JCR,1}, PH_{JCR,2}}, where PH is a power headroom associated with the communication only mode, PH_{JCR,1} is a power headroom associated with the first sensing configuration or the first radar beam (radar beam-1), and PH_{JCR,2} is a power headroom associated with the second sensing configuration or the second radar beam (radar beam-2).

Referring again to FIG. 4, in some implementations, power headroom report 408 or 474 may include or indicate a power headroom report for communication during joint communication-radar sensing (JCS) mode. UE 115 may transmit power headroom report 408 or 474 for communication during joint communication-radar sensing mode. A power headroom for communication during the JCR mode may be calculated as:

$${PH}_{JCR} = {P}_{MAX} - \{ {P}_{PUSCH} + b \} - {P}_{rad} ,$$

where Prad is the Tx power used for or associated with a radar sensing configuration (e.g., 410). Additionally, or alternatively, the power headroom PH_{JCR} may be determined for or based on one or more beams of the radar sensing configuration (e.g., 410).

In some implementations, generation or transmission of power headroom report 408 or 474 may be based on (or triggered by) UE 115 switching from a communication only mode to JCR mode, from the communication only mode to a sensing only mode, from a sensing only mode to JCR mode, from a first sensing configuration (during JCR mode) to a second sending configuration (during JCR mode), or from JCR mode to communication only mode or sensing only mode. For example, generation or transmission of power headroom report 408 or 474 may be based on UE 115 changing a sensing configuration during JCR mode. In some implementations, generation or transmission of power headroom report 408 or 474 may be based on (or triggered by) a change (e.g., a reduction or an increase) in sensing transmission power. For example, generation or transmission of power headroom report 408 or 474 may be based on (or triggered by) a change (e.g., a reduction or an increase) in sensing transmission power that is greater than or equal to a threshold. Additionally, or alternatively, the change in the sending transmission power may be a change that occurs without changing a communication beam.

In some implementations, power headroom report 408 or 474, associated with time T₂ (of FIG. 5 or 6), includes power headroom (e.g., PH_{JCR,1}) for the a sensing configuration, such as the first sensing configuration, along with the power headroom (e.g., PH) for the communication only mode. Additionally, or alternatively, power headroom report 408 or 474, associated with time T₃ (of FIG. 5 or 6), includes power headroom (e.g., PH_{JCR,2}) for the a sensing configuration, such as the second sensing configuration, along with the power headroom (e.g., PH) for the communication only mode.

In some implementations, generation or transmission of power headroom report 408 or 474, or of a power headroom, may be triggered based on a change in a mode (e.g., 411), a change in a sensing configuration (e.g., 410), or a combination thereof. For example, generation or transmission of power headroom report 408 or 474, or of a power headroom, may be triggered based on a change in a sensing configuration (e.g., a sensing mode configuration) during the JCR mode.

In some implementations, a Tx power (e.g., 409) used for a given radar sensing configuration, Prad, may also be included in or indicated by power headroom report 408 or 474. To illustrate, the Tx power (e.g., 409) used for a given radar sensing configuration, Prad, may also be included in or indicated by power headroom report 408 or 474 that is transmitted to base station 105 to enable base station 105 to calculate a pathloss of a communication channel.

In some implementations, power headroom report 408 or 474 includes power headroom for multiple sensing configurations (or multiple sensing beams) along with the power headroom (PH) for the communication only mode, e.g., the communication beam. Additionally, or alternatively, a sensing configuration (e.g., 410) may include or indicate a number of radar beams as well as, for each beam, a beamwidth of the beam, a pointing direction of the beam, or a combination thereof. Additionally, or alternatively, in some implementations, power headroom report 408 or 474 (or a power headroom) for JCR includes PH_{JCR} for each beam individually, for one or more sets of multiple beams, or a combination thereof.

In some implementations, base station 105 may indicate to UE 115 which sensing configuration (e.g., 410) should be used by UE 115. For example, base station 105 may indicate to UE 115 which sensing configuration should be used by UE 115 to report sensing power headroom (e.g., PH_{JCR}). In some implementations, base station 105 may transmit configuration information 470 to UE 115 and configuration information 470 may include or indicate sensing configuration 410 for use by UE 115 to perform one or more sensing operations, determine power headroom for one or more sensing beam, generate power headroom report 408 or 474, one or more trigger conditions for generating or determining a power headroom or a power headroom report (e.g., 408), or a combination thereof.

In some implementations, sensing configuration 410 may be used for one or more transmission (e.g., one or more future transmission), such as during a scanning mode (PH_{JCR,s}), a tracking mode (PH_{JCR,T}), a sensing transmission PHR (PH_{JCR}), communication only PHR (PH), or a combination thereof. Additionally, or alternatively, sensing configuration 410 (e.g., a sensing mode configuration) may be included in a set or codebook of sensing configurations that is known to UE 115, base station 105, or both. UE 115 or base station 105 may be configured to indicate sensing configuration 410 to another device based on the sensing configuration set/codebook, such as using an index value that corresponds to a particular sensing configuration of the sensing configuration set/codebook.

In some implementations, base station 105 is configured to indicate which sensing configuration(s) 410 should be used to report power headroom for a current mode, a future mode, or a combination thereof. To illustrate, base station 105 may transmit configuration information 470 which indicates which sensing configuration(s) 410 should be used to report power headroom for a current JCR mode, a future JCR mode, or a combination thereof.

In some implementations, UE 115 indicates to base station 105 which sensing configuration is used by UE 115 to report sensing PHR. In some implementations, UE 115 may select a sensing configuration (e.g., 410) based on one or more criteria, such as a max transmit radar beam gain, a max beamwidth, a min beamwidth, or a combination thereof, as illustrate, non-limiting examples. Additionally, or alternatively, base station 105 may indicate the one or more criteria to UE 115. For example, the configuration information 470 may include or indicate the one or more criteria to be used by UE 115 to select the sensing configuration. In some implementations, power headroom report 408 or 474 may include or indicate a sensing power headroom and an index value of the sensing configuration set/codebook (known to UE 115 and base station 105) that indicates which sensing configuration is used to generate the sensing power headroom.

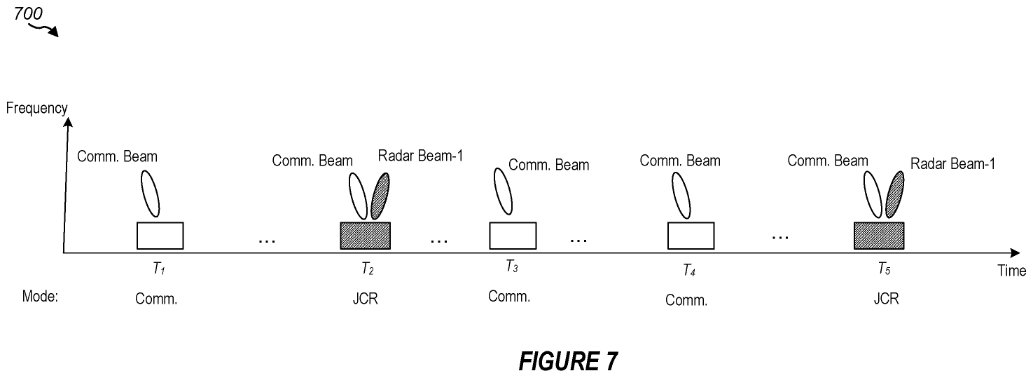

Referring to FIG. 7, FIG. 7 shows another example 700 of operations that support that support a power headroom report according to one or more aspects are shown. For example, the one or more operations may be performed by UE 115. FIG. 7 shows communication at different times and indicates, for each time, a corresponding mode (e.g., 411). To illustrate, at a first time T₁, UE 115 operates in a communication only mode. At a second time T₂, UE 115 operates in a JCR mode. The JCR mode (e.g., communication mode and sensing mode) at the second time T₂ includes a communication beam and a first radar beam (radar beam-1). The first radar beam (radar beam-1) may be associated with a first sensing configuration (e.g., 410). At a third time T₃, UE 115 operates in the communication mode. At a fourth time T₄, UE 115 operates in the communication mode. At a fifth time T₅, UE 115 operates in the JCR mode. The JCR mode (e.g., communication mode and sensing mode) at the fifth time T₅ includes the communication beam and the first radar beam (radar beam-1). The first radar beam (radar beam-1) may be associated with the first sensing configuration (e.g., 410). As shown in FIG. 7, the JCR mode may be non-contiguous in time domain. Additionally, or alternatively, FIG. 7 indicates that UE 115 may switch between the communication mode and the JCR mode.

Referring again to FIG. 4, in some implementations, a JCR mode (e.g., 411) may be non-contiguous in time domain. Additionally, or alternatively, UE 115 may switch communication (e.g., communication only) and JCR modes. In such situations (e.g., JCR mode is non-contiguous or switching between modes, power headroom reporting may be configured to reduce the overhead for power headroom reporting at every change in mode—e.g., transition from communication to JCR mode or vice versa. For example, determining power headroom may be triggered periodically for a JCR mode. The period of reporting could be based on a coherent processing interval. As another example, determining power headroom may be triggered at a start (e.g., only at a start) of the sensing transmission for a given sensing configuration. As another example, determining power headroom may be triggered at one or more times as indicated by base station 105 to UE 115. As another example, determining power headroom may be triggered when power headroom for a JCR mode changes by greater than or equal to a threshold amount for a given sensing configuration. In some implementations, two or more of the above examples may be used (in combination or individually) to trigger determining power headroom. Additionally, or alternatively, the above examples may be used to generate or transmit power headroom report 408 or 474.

During operation of wireless communications system 400, base station 105 may transmit configuration information 470 to UE 115. The UE 115 may receive configuration information 470.

In some implementations, configuration information 470 may include or indicate a sensing configuration, a power headroom to be reported for the sensing configuration or a JCR sensing mode, or a combination thereof. For example, the sensing configuration may include or correspond to sensing configuration 410. In some implementations, configuration information 470 may include an index value associated with a sensing mode codebook of one or more sending configurations. The index value may correspond to the sensing configuration of the one or more sensing configurations. UE 115 may configure sensing device 415 based on sensing configuration 410. Additionally, or alternatively, UE 115 may perform one or more sensing operations based on the sensing configuration 410.

In some implementations, configuration information 470 may include or indicate a selection parameter. The selection parameter may include or indicate a maximum radar beam gain, a maximum beamwidth, a minimum beamwidth, or a combination thereof. UE 115 may select, based on the selection parameter, sensing configuration 410 from one or more sensing configurations. In some implementations, UE 115 may include an indicator in power headroom report 474 that indicates the selected sensing configuration 410. For example, the indicator may include an index value (associated with a sensing mode codebook of one or more sending configurations) and the index value may correspond to the selected sensing configuration (e.g., 410).

In some implementations, UE 115 may perform one or more transmissions. The one or more transmission may include a communication transmission, a sensing transmission, or a combination thereof. Based on the one or more transmissions, UE 115 may determine a power headroom. For example, UE 115 may calculate a power headroom for communication during the JCR sensing mode. UE 115 may generate and transmit power headroom report 474, such as a power headroom report, that includes or indicates the determined power headroom. In some implementations, UE 115 may generate power headroom report 408 or power headroom report 474 that is associated with or for communication during a JCR sensing mode. Power headroom report 408 (or power headroom report 474) may be generated based on Tx power 409 (of a radar sensing beam) associated with sensing configuration 410. In some implementations, power headroom report 408 (or power headroom report 474) may indicate Tx power 409 for sensing configuration 410 to enable base station 105 to calculate a pathloss for a communication channel.

UE 115 may transmit power headroom report 474 to base station 105. Power headroom report 474 may include an indicator that indicates sensing configuration 410. In some implementations, power headroom report 408 (or power headroom report 474) may be generated or transmitted periodically during the JCR sensing mode, at a start of a sensing transmission based on a sensing configuration, based on a time indicated by a base station, based on a change in power headroom for a sensing configuration that is greater than or equal to a threshold, or a combination thereof.

In some implementations, UE 115 may switch from a communication mode (e.g., a communication only mode) to the JCR sensing mode, or a first sensing configuration during the JCR sensing mode to a second sensing configuration during the JCR sensing mode. Power headroom report 408 (or a power headroom) may be generated or transmitted based on the switch, such as from the communication mode to the JCR sensing mode, or the first sensing configuration to the second sensing configuration.

In some implementations, UE 115 may switch, during the JCR sensing mode, from a first sensing configuration to a second sensing configuration. The first sensing configuration may be associated with a first sensing beam and the second sensing configuration may be associated with a second sensing beam. The first sensing beam and the second sensing beam may be the same beam (e.g., have the same beam criteria/beam characteristics) or may be different beams. UE 115 may perform a comparison based on a threshold and a change in a sensing Tx power based on the switch from the first sensing configuration to the second sensing configuration. Power headroom report 408 (or power headroom report 474) may be generated or transmitted based on the change being greater than or equal to the threshold, or a Tx power of a communication beam remaining unchanged based on the switch from the first sensing configuration to the second sensing configuration.

As described with reference to FIG. 4, the present disclosure provides techniques for supporting a sensing charging subscription. The techniques described provide processes, information, and signaling for UE 115 to generate a power headroom report (e.g., 474) for communication during a joint communication and radar sensing mode. The power headroom report may enable setting of one or more communication transmit parameter settings, such as a bandwidth, a minimum communication range (MCR), or a carrier aggregation configuration.

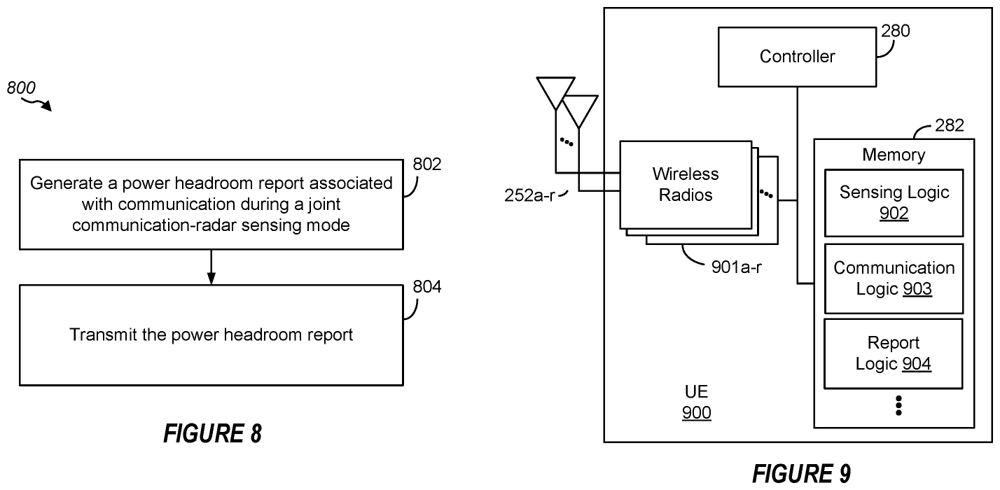

FIG. 8 is a flow diagram illustrating an example process 800 that supports a power headroom report according to one or more aspects. Operations of process 800 may be performed by a UE, such as UE 115 described above with reference to FIGS. 1-4 or a UE described with reference to FIG. 9. For example, example operations (also referred to as “blocks”) of process 800 may enable UE 115 to support a power headroom report.

In block 802, the UE generates a power headroom report associated with communication during a JCR sensing mode. The power headroom report may include or correspond to power headroom report 408 or power headroom report 474. The JCR sensing mode may include or correspond to mode 411. In some implementations, the power headroom report is for communication during the JCR sensing mode. The power headroom report may be based on a Tx power associated with a sensing configuration. The sensing configuration may include or correspond to sensing configuration 410. The sensing configuration is associated with a monostatic sensing operation or a bistatic sensing operation. In some implementations, the UE calculates a power headroom for communication during the JCR sensing mode. The power headroom may be calculated based on a Tx power (e.g., 409) associated with a sensing configuration (e.g., 410). In some implementations, the power headroom report indicates the Tx power for the sensing configuration to enable a base station (e.g., 105) to calculate a pathloss for a communication channel.

In block 804, the UE transmits the power headroom report. For example, the UE 115 may transmit power headroom report 474 to base station 105.

In some implementations, the power headroom report indicates a power headroom for a sense beam associated with a sensing configuration, a Tx power associated with the sensing configuration, a number of radar sensing beam, a power headroom for a communication mode/configuration, or a combination thereof. Additionally, or alternatively, the power headroom report may indicate, for at least one radar sensing beam of one or more radar sensing beams, a power headroom of the at least one sensing beam, a beamwidth of the at least one radar sensing beam, a beam direction of the at least one radar sensing beam, or a combination thereof.

In some implementations, the UE switches from a communication mode to the JCR sensing mode, or a first sensing configuration during the JCR sensing mode to a second sensing configuration during the JCR sensing mode. The power headroom report may be generated or transmitted based on the switch from the communication mode to the JCR sensing mode, or the first sensing configuration to the second sensing configuration. For example, the power headroom report may be generated or transmitted based on the switch from the communication mode to the JCR sensing mode. As another example, the power headroom report may be generated or transmitted based on the switch from the first sensing configuration to the second sensing configuration.

In some implementations, the UE switches, during the JCR sensing mode, from a first sensing configuration to a second sensing configuration. The first sensing configuration may include a first sense beam and the second sensing configuration may include a second sense beam. The first sense beam and the second sense beam may be the same beam or may be different beams. In some implementations, the UE performs a comparison based on a threshold and a change in a sensing Tx power based on the switch from the first sensing configuration to the second sensing configuration. The power headroom report may be generated or transmitted based on the change being greater than or equal to the threshold, a Tx power of a communication beam remaining unchanged based on the switch from the first sensing configuration to the second sensing configuration, or a combination thereof.

In some implementations, the UE receives, from a base station, configuration information. For example, the configuration information may include or correspond to configuration information 470, UE information 464, sensing configuration 410, or mode 411. The configuration information may indicate a sensing configuration (e.g., 410), a power headroom to be reported for the sensing configuration, or a combination thereof. Additionally, or alternatively, the configuration information includes an index value associated with a sensing mode codebook of one or more sending configurations. The index value may correspond to the sensing configuration of the one or more sensing configurations. The sensing configuration may be associated with a scanning mode, a tracking mode, or the JCR sensing mode. In some implementations, the UE may perform one or more sensing operations based on the sensing configuration. For example, the UE may perform the one or more sensing operations using sensing device 415.

In some implementations, the configuration information received by the UE indicates a selection parameter. The selection parameter may include or indicate a maximum radar beam gain, a maximum beamwidth, a minimum beamwidth, or a combination thereof. The UE may select, based on the selection parameter, a sensing configuration from one or more sensing configurations. The power headroom report may include an indicator that indicates the selected sensing configuration. For example, the indicator may be an index value that corresponds to the selected sensing configuration selected from one or more sensing configurations.

In some implementations, the UE may generate or transmit the power headroom report periodically during the JCR sensing mode, at a start of a sensing transmission based on a sensing configuration, based on a time indicated by a base station, based on a change in power headroom for a sensing configuration that is greater than or equal to a threshold, or a combination thereof. In some implementations, the configuration information (e.g., 470), the sensing configuration 410, or the mode 411 may indicate when a power headroom, the power headroom report, or a combination thereof, is to be generated or transmitted.

FIG. 9 is a block diagram of an example UE 900 that supports a power headroom report according to one or more aspects. UE 900 may be configured to perform operations, including the blocks of a process described with reference to FIG. 8. In some implementations, UE 900 includes the structure, hardware, and components shown and described with reference to UE 115 of FIGS. 1-4. For example, UE 900 includes controller 280, which operates to execute logic or computer instructions stored in memory 282, as well as controlling the components of UE 900 that provide the features and functionality of UE 900. UE 900, under control of controller 280, transmits and receives signals via wireless radios 901a-r and antennas 252a-r. Wireless radios 901a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include sensing logic 902, communication logic 903, and report logic 904. Sensing logic 902 may be configured to enable one or sensing operations. Communication logic 903 may be configured to enable communication between UE 900 and one or more other devices. Report logic 904 may be configured to enable generation of one or more reports, such as a power headroom report (e.g., 408 or 474). In some implementations, the one or more reports may include or correspond to power headroom report 474. UE 900 may receive signals from or transmit signals to one or more network entities, such as base station 105 of FIGS. 1-4, or a base station as illustrated in FIG. 11.

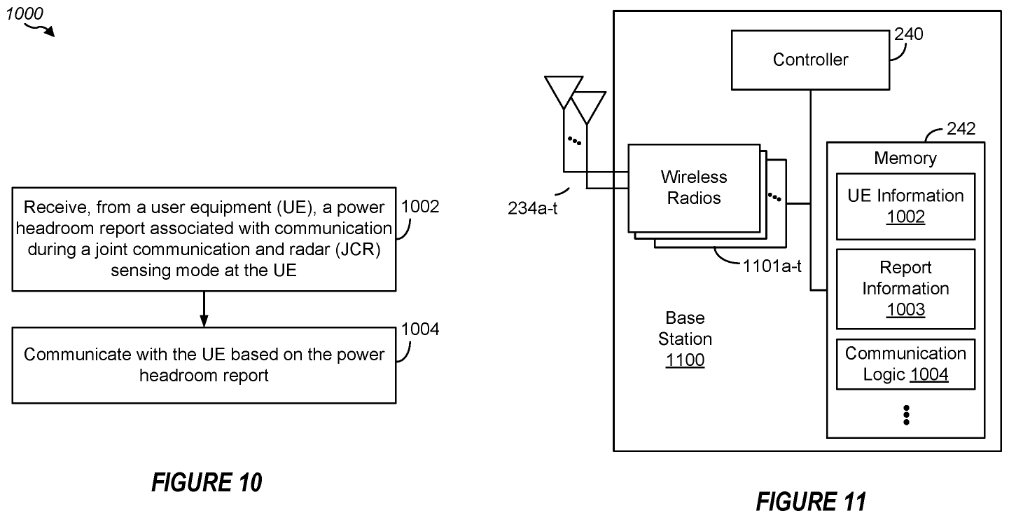

FIG. 10 is a flow diagram illustrating an example process 1000 that supports a power headroom report according to one or more aspects. Operations of process 1000 may be performed by a base station, such as base station 105 described above with reference to FIGS. 1-4. For example, example operations of process 1000 may enable the base station to support a power headroom report. In some other implementations, process 1000 may be performed by a network entity.

At block 1002, the base station receives, from a UE, a power headroom report associated with communication during a JCR sensing mode at the UE. The UE may include or correspond to UE 115. The power headroom report may include or correspond to power headroom report 408 or power headroom report 474. The JCR sensing mode may include or correspond to mode 411. The JCR sensing mode may be associated with a communication configuration and a sensing configuration (e.g., 410).

At block 1004, the base station communicates with the UE based on the power headroom report. For example, the base station may receive an uplink communication from the UE.

In some implementations, the power headroom report may indicate a power headroom for a sense beam associated with a sensing configuration, a Tx power associated with the sensing configuration, a number of radar sensing beam, a power headroom for a communication mode, or a combination thereof. Additionally, or alternatively, the power headroom report may indicate, for at least one radar sensing beam of one or more radar sensing beams, a power headroom of the at least one sensing beam, a beamwidth of the at least one radar sensing beam, a beam direction of the at least one radar sensing beam, or a combination thereof.

In some implementations, the base station may determine, based on the power headroom report, a Tx power for a sensing configuration. The Tx power may include or correspond to Tx power 409, UE information 464, or a combination thereof. Based on the Tx power, the base station may calculate a pathloss for a communication channel. The base station may communicate with the UE via the communication, based one the path loss, or a combination thereof.

In some implementations, the bases station my transmit configuration information to the UE. The configuration information may include or correspond to configuration information 470, sensing configuration 410, mode 411, or a combination thereof. The configuration information may indicate a sensing configuration (e.g., 410), a power headroom to be reported for the sensing configuration, or a combination thereof. In some implementations, the configuration information includes an index value associated with a sensing mode codebook of one or more sending configurations. The index value may correspond to the sensing configuration of the one or more sensing configurations. Additionally, or alternatively, the configuration information may indicate that the power headroom report is to be generated or transmitted periodically during the JCR sensing mode, at a start of a sensing transmission based on a sensing configuration, based on a time indicated by a base station, based on a change in power headroom for a sensing configuration that is greater than or equal to a threshold, or a combination thereof.

In some implementations, the configuration information indicates a selection parameter. The selection parameter may include a maximum radar beam gain, a maximum beamwidth, a minimum beamwidth, or a combination thereof. The UE may be configured to select a sensing configuration (e.g. 410) based on the selection parameter. The power headroom report may include an indicator that indicates a selected sensing configuration selected by the UE based on the selection parameter.

FIG. 11 is a block diagram of an example base station 1100 that supports a power headroom report according to one or more aspects. Base station 1100 may be configured to perform operations, including the blocks of processes described with reference to FIG. 10. In some implementations, base station 1100 includes the structure, hardware, and components shown and described with reference to base station 105 of FIGS. 1-4. For example, base station 1100 may include controller 240, which operates to execute logic or computer instructions stored in memory 242, as well as controlling the components of base station 1100 that provide the features and functionality of base station 1100. Base station 1100, under control of controller 240, transmits and receives signals via wireless radios 1101a-t and antennas 234a-t. Wireless radios 1101a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include UE information 1102, report information 1103, and communication logic 1104. UE information 1102 may include or correspond to power headroom report 408, UE information 464, or capability information 465. Report information 1103 may include or correspond to power headroom report 408 or 474. Communication logic 1104 may be configured to enable communication between base station 1100 and one or more other devices. Base station 1100 may receive signals from or transmit signals to one or more UEs, such as UE 115 of FIGS. 1-4 or UE 900 of FIG. 9.

It is noted that one or more blocks (or operations) described with reference to FIG. 8 or 10 may be combined with one or more blocks (or operations) described with reference to another of the figures. For example, one or more blocks (or operations) of FIG. 8 may be combined with one or more blocks (or operations) of FIG. 10. As another example, one or more blocks associated with FIG. 6 may be combined with one or more blocks associated with FIG. 4. As another example, one or more blocks associated with FIG. 8 may be combined with one or more blocks associated with FIG. 4. As another example, one or more blocks associated with FIG. 8 or 10 may be combined with one or more blocks (or operations) associated with FIGS. 1-7. Additionally, or alternatively, one or more operations described above with reference to FIGS. 1-7 may be combined with one or more operations described with reference to FIG. 9 or 11.

In one or more aspects, techniques for supporting a power headroom report may include additional aspects, such as any single aspect or any combination of aspects described below or in connection with one or more other processes or devices described elsewhere herein. In a first aspect, techniques for supporting a power headroom report may include generating a power headroom report associated with communication during a JCR sensing mode. The techniques may further include transmitting the power headroom report. In some examples, the techniques in the first aspect may be implemented in a method or process. In some other examples, the techniques of the first aspect may be implemented in a wireless communication device, which may include a UE or a component of a UE. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface, a radar sensing interface, or a combination thereof) that includes a transmitter, a receiver, or a combination thereof. Additionally, or alternatively, the wireless communication device may include one or more means configured to perform operations described herein.

In a second aspect, in combination with the first aspect, the power headroom report is generated based on a Tx power associated with a sensing configuration, the power headroom report is for communication during the JCR sensing mode, or a combination thereof.

In a third aspect, in combination with the first aspect or the second aspect, the sensing configuration is associated with a monostatic sensing operation.

In a fourth aspect, in combination with one or more of the first aspect through the third aspect, the power headroom report indicates the Tx power for the sensing configuration to enable a base station to calculate a pathloss for a communication channel.

In a fifth aspect, in combination with one or more of the first aspect through the fourth aspect, the techniques further include the power headroom report indicates a power headroom for a sense beam associated with a sensing configuration.

In a sixth aspect, in combination with one or more of the first aspect through the fifth aspect, the power headroom report indicates a Tx power associated with a sensing configuration.

In a seventh aspect, in combination with one or more of the first aspect through the sixth aspect, the power headroom report indicates a number of radar sensing beam.

In an eighth aspect, in combination with one or more of the first aspect through the seventh aspect, the power headroom report indicates, for at least one radar sensing beam of one or more radar sensing beams, a power headroom of the at least one sensing beam, a beamwidth of the at least one radar sensing beam, a beam direction of the at least one radar sensing beam, or a combination thereof.

In a ninth aspect, in combination with one or more of the first aspect through the eighth aspect, the power headroom report indicates a power headroom for a communication mode.

In a tenth aspect, in combination with one or more of the first aspect through the ninth aspect, the techniques further include calculating a power headroom for communication during the JCR sensing mode.

In an eleventh aspect, in combination with the tenth aspect, the power headroom is calculated based on a Tx power associated with a sensing configuration.

In a twelfth aspect, in combination with one or more of the first aspect through the eleventh aspect, the techniques further include switching from a communication mode to the JCR sensing mode, or a first sensing configuration during the JCR sensing mode to a second sensing configuration during the JCR sensing mode.

In a thirteenth aspect, in combination with the twelfth aspect, the power headroom report is generated or transmitted based on the switch from the communication mode to the JCR sensing mode, or the first sensing configuration to the second sensing configuration.

In a fourteenth aspect, in combination with the first aspect, the techniques further include switching, during the JCR sensing mode, from a first sensing configuration to a second sensing configuration.

In a fifteenth aspect, in combination with the fourteenth aspect, the techniques further include performing a comparison based on a threshold and a change in a sensing Tx power based on the switch from the first sensing configuration to the second sensing configuration.

In a sixteenth aspect, in combination with the fifteenth aspect, the power headroom report is generated or transmitted based on the change being greater than or equal to the threshold.

In a seventeenth aspect, in combination with the fifteen aspect or the sixteenth aspect, the power headroom report is generated or transmitted based on a Tx power of a communication beam remaining unchanged based on the switch from the first sensing configuration to the second sensing configuration.

In an eighteenth aspect, in combination with one or more of the first aspect through the seventeenth aspect, the techniques further include receiving, from a base station, configuration information.

In a nineteenth aspect, in combination with the eighteenth aspect, the configuration information indicates a sensing configuration, a power headroom to be reported for the sensing configuration, or a combination thereof.

In a twentieth aspect, in combination with the eighteenth aspect or the nineteenth aspect, the techniques further include performing one or more sensing operations based on the sensing configuration.

In a twenty-first aspect, in combination with one or more of the eighteenth aspect through the twentieth aspect, the configuration information includes an index value associated with a sensing mode codebook of one or more sending configurations.

In a twenty-second aspect, in combination with the twenty-first aspect, the index value correspond to the sensing configuration of the one or more sensing configurations.

In a twenty-third aspect, in combination with one or more of the eighteenth aspect through the twenty-second aspect, the sensing configuration is associated with a scanning mode, a tracking mode, or the JCR sensing mode.

In a twenty-fourth aspect, in combination with one or more of the first aspect through the seventeenth aspect, the techniques further include receiving, from a base station, configuration information.

In a twenty-fifth aspect, in combination with the twenty-fourth aspect, the configuration information indicates a selection parameter.

In a twenty-sixth aspect, in combination with the twenty-fifth aspect, the selection parameter includes a maximum radar beam gain, a maximum beamwidth, a minimum beamwidth, or a combination thereof.

In a twenty-seventh aspect, in combination with the twenty-fifth aspect or the twenty-sixth aspect, the techniques further include selecting, based on the selection parameter, a sensing configuration from one or more sensing configurations.

In a twenty-eighth aspect, in combination with the twenty-seventh aspect, the power headroom report includes an indicator that indicates the selected sensing configuration.

In a twenty-ninth aspect, in combination with one or more of the first aspect through the twenty-eighth aspect, the power headroom report is generated or transmitted periodically during the JCR sensing mode.

In a thirtieth aspect, in combination with one or more of the first aspect through the twenty-ninth aspect, the power headroom report is generated or transmitted at a start of a sensing transmission based on a sensing configuration.

In a thirty-first aspect, in combination with one or more of the first aspect through the thirtieth aspect, the power headroom report is generated or transmitted based on a time indicated by a base station.

In a thirty-second aspect, in combination with one or more of the first aspect through the thirty-first aspect, the power headroom report is generated or transmitted based on a change in power headroom for a sensing configuration that is greater than or equal to a threshold.

In one or more aspects, techniques for supporting a power headroom report may include additional aspects, such as any single aspect or any combination of aspects described below or in connection with one or more other processes or devices described elsewhere herein. In a thirty-third aspect, techniques for supporting a power headroom report may include receiving, from a UE, a power headroom report associated with communication during a JCR sensing mode. The techniques may further include communicating with the UE based on the power headroom report. In some examples, the techniques in the thirty-third aspect may be implemented in a method or process. In some other examples, the techniques of the thirty-third aspect may be implemented in a wireless communication device, such as network entity, which may include a base station or a component of a base station, a UE or a component of a UE, a roadside unit or a component of a roadside unit. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface, a sensing interface, or a combination thereof) that includes a transmitter, a receiver, or a combination thereof. Additionally, or alternatively, the wireless communication device may include one or more means configured to perform operations described herein.

In a thirty-fourth aspect, in combination with the thirty-third aspect, the power headroom report is for communication during the JCR sensing mode.

In a thirty-fifth aspect, in combination with the thirty-third aspect or the thirty-fourth aspect, the JCR sensing mode is associated with a communication configuration and a sensing configuration.

In a thirty-sixth aspect, in combination with one or more of the thirty-third aspect through the thirty-fifth aspect, the power headroom report indicates a power headroom for a sense beam associated with a sensing configuration.

In a thirty-seventh aspect, in combination with one or more of the thirty-third aspect through the thirty-sixth aspect, the power headroom report indicates a transmit (Tx) power associated with the sensing configuration.

In a thirty-eighth aspect, in combination with one or more of the thirty-third aspect through the thirty-seventh aspect, the power headroom report indicates a number of radar sensing beam.

In a thirty-ninth aspect, in combination with one or more of the thirty-third aspect through the thirty-eighth aspect, the power headroom report indicates, for at least one radar sensing beam of one or more radar sensing beams, a power headroom of the at least one sensing beam, a beamwidth of the at least one radar sensing beam, a beam direction of the at least one radar sensing beam, or a combination thereof.

In a fortieth aspect, in combination with one or more of the thirty-third aspect through the thirty-ninth aspect, the power headroom report indicates a power headroom for a communication mode.

In a forty-first aspect, in combination with one or more of the thirty-third aspect through the fortieth aspect, the techniques further include determining, based on the power headroom report, a Tx power for a sensing configuration.

In a forty-second aspect, in combination with the forty-first aspect, the techniques further include calculating, based on the Tx power, a pathloss for a communication channel.

In a forty-third aspect, in combination with one or more of the thirty-third aspect through the forty-second aspect, the techniques further include transmitting, to the UE, configuration information,

In a forty-fourth aspect, in combination with the forty-third aspect, the configuration information indicates a sensing configuration, a power headroom to be reported for the sensing configuration, or a combination thereof.

In a forty-fifth aspect, in combination with the forty-third aspect or the forty-fourth aspect, the configuration information includes an index value associated with a sensing mode codebook of one or more sending configurations, the index value correspond to the sensing configuration of the one or more sensing configurations.

In a forty-sixth aspect, in combination with the forty-third aspect, the configuration information indicates a selection parameter, the selection parameter includes a maximum radar beam gain, a maximum beamwidth, a minimum beamwidth, or a combination thereof.

In a forty-seventh aspect, in combination with the forty-sixth aspect, the power headroom report includes an indicator that indicates a selected sensing configuration selected by the UE based on the selection parameter.

In a forty-eighth aspect, in combination with the forty-third aspect, the configuration information indicates the power headroom report is to be generated or transmitted periodically during the JCR sensing mode, at a start of a sensing transmission based on a sensing configuration, based on a time indicated by the network entity, based on a change in power headroom for a sensing configuration that is greater than or equal to a threshold, or a combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-11 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication performed by a user equipment (UE), the method comprising:
generating a power headroom report associated with communication during a joint communication and radar (JCR) sensing mode; and
transmitting the power headroom report.

2. The method of claim 1, wherein:
the power headroom report is generated based on a transmit (Tx) power associated with a sensing configuration,
the sensing configuration is associated with a monostatic sensing operation, the power headroom report indicates the Tx power for the sensing configuration to enable a base station to calculate a pathloss for a communication channel, or
a combination thereof.

3. The method of claim 1, wherein the power headroom report indicates:
a power headroom for a sense beam associated with a sensing configuration, a transmit (Tx) power associated with the sensing configuration,
a number of radar sensing beam,
for at least one radar sensing beam of one or more radar sensing beams, a power headroom of the at least one sensing beam, a beamwidth of the at least one radar sensing beam, a beam direction of the at least one radar sensing beam, or a combination thereof, a power headroom for a communication mode, or
a combination thereof.

4. The method of claim 1, further comprising:
calculating a power headroom for communication during the JCR sensing mode, and
the power headroom is calculated based on a transmit (Tx) power associated with a sensing configuration.

5. The method of claim 1, further comprising:
switching from:
a communication mode to the JCR sensing mode; or
a first sensing configuration during the JCR sensing mode to a second sensing configuration during the JCR sensing mode; and
wherein the power headroom report is generated or transmitted based on the switch from:
the communication mode to the JCR sensing mode; or
the first sensing configuration to the second sensing configuration.

6. The method of claim 1, further comprising:
switching, during the JCR sensing mode, from a first sensing configuration to a second sensing configuration; and
performing a comparison based on a threshold and a change in a sensing transmit (Tx) power based on the switch from the first sensing configuration to the second sensing configuration, and
wherein the power headroom report is generated or transmitted based on:
the change being greater than or equal to the threshold,
a Tx power of a communication beam remaining unchanged based on the switch from the first sensing configuration to the second sensing configuration, or a combination thereof.

7. The method of claim 1, further comprising:
receiving, from a base station, configuration information, the configuration information indicates a sensing configuration, a power headroom to be reported for the sensing configuration, or a combination thereof; and
performing one or more sensing operations based on the sensing configuration.

8. The method of claim 7, wherein:
the configuration information includes an index value associated with a sensing mode codebook of one or more sending configurations, the index value correspond to the sensing configuration of the one or more sensing configurations,
the sensing configuration is associated with a scanning mode, a tracking mode, or the JCR sensing mode, or
a combination thereof.

9. The method of claim 1, further comprising:
receiving, from a base station, configuration information, the configuration information indicates a selection parameter, the selection parameter includes a maximum radar beam gain, a maximum beamwidth, a minimum beamwidth, or a combination thereof; and
selecting, based on the selection parameter, a sensing configuration from one or more sensing configurations, and
wherein the power headroom report includes an indicator that indicates the selected sensing configuration.

10. The method of claim 1, wherein the power headroom report is generated or transmitted:
periodically during the JCR sensing mode,
at a start of a sensing transmission based on a sensing configuration,
based on a time indicated by a base station,
based on a change in power headroom for a sensing configuration that is greater than or equal to a threshold, or
a combination thereof.

11. A user equipment (UE) comprising:
at least one memory; and
at least one processor communicatively coupled with the at least one memory, the at least one processor operable to cause the UE to:
generate a power headroom report associated with communication during a joint communication and radar (JCR) sensing mode; and
transmit the power headroom report.

12. The UE of claim 11, wherein:
the power headroom report is generated based on a transmit (Tx) power associated with a sensing configuration,
the sensing configuration is associated with a monostatic sensing operation, the power headroom report indicates the Tx power for the sensing configuration to enable a base station to calculate a pathloss for a communication channel, or a combination thereof.

13. The UE of claim 11, wherein the power headroom report indicates:
a power headroom for a sense beam associated with a sensing configuration, a transmit (Tx) power associated with the sensing configuration,
a number of radar sensing beam,
for at least one radar sensing beam of one or more radar sensing beams, a power headroom of the at least one sensing beam, a beamwidth of the at least one radar sensing beam, a beam direction of the at least one radar sensing beam, or a combination thereof, a power headroom for a communication mode, or
a combination thereof.

14. The UE of claim 11, wherein the at least one processor is further operable to cause the UE to:
calculate a power headroom for communication during the JCR sensing mode, and
the power headroom is calculated based on a transmit (Tx) power associated with a sensing configuration.

15. The UE of claim 11, wherein the at least one processor is further operable to cause the UE to:
switch from:
a communication mode to the JCR sensing mode; or
a first sensing configuration during the JCR sensing mode to a second sensing configuration during the JCR sensing mode; and
wherein the power headroom report is generated or transmitted based on the switch from:
the communication mode to the JCR sensing mode; or
the first sensing configuration to the second sensing configuration.

16. The UE of claim 11, wherein the at least one processor is further operable to cause the UE to:
switch, during the JCR sensing mode, from a first sensing configuration to a second sensing configuration; and
perform a comparison based on a threshold and a change in a sensing transmit (Tx) power based on the switch from the first sensing configuration to the second sensing configuration, and
wherein the power headroom report is generated or transmitted based on:
the change being greater than or equal to the threshold,
a Tx power of a communication beam remaining unchanged based on the switch from the first sensing configuration to the second sensing configuration, or a combination thereof.

17. The UE of claim 11, wherein the at least one processor is further operable to cause the UE to:
receive, from a base station, configuration information, the configuration information indicates a sensing configuration, a power headroom to be reported for the sensing configuration, or a combination thereof; and
performing one or more sensing operations based on the sensing configuration.

18. The UE of claim 11, wherein the at least one processor is further operable to cause the UE to:
receive, from a base station, configuration information, the configuration information indicates a selection parameter, the selection parameter includes a maximum radar beam gain, a maximum beamwidth, a minimum beamwidth, or a combination thereof; and
select, based on the selection parameter, a sensing configuration from one or more sensing configurations, and
wherein the power headroom report includes an indicator that indicates the selected sensing configuration.

19. The UE of claim 11, wherein the power headroom report is generated or transmitted:
periodically during the JCR sensing mode,
at a start of a sensing transmission based on a sensing configuration,
based on a time indicated by a base station,
based on a change in power headroom for a sensing configuration that is greater than or equal to a threshold, or
a combination thereof.

20. A method of wireless communication performed by a network entity, the method comprising:
receiving, from a user equipment (UE), a power headroom report associated with communication during a joint communication and radar (JCR) sensing mode; and communicating with the UE based on the power headroom report.

21-30. (canceled)
